(19) United States
(12) Patent Application Publication
(10) Pub. No.: US 2012/0148926 A1
(43) Pub. Date: Jun. 14, 2012

(54) FUEL CELL DEHUMIDIFICATION SYSTEM AND METHOD

(75) Inventors: Daniel Carrington Betts, Parkland, FL (US); Vensa Stanic, West Palm Beach, FL (US)

(73) Assignee: ENERFUEL, INC., West Palm Beach, FL (US)

(21) Appl. No.: 12/966,564

(22) Filed: Dec. 13, 2010

(51) Int. Cl. H01M 8/06

(52) U.S. Cl. 429/414

(57) ABSTRACT

A system and method for dehumidifying a fuel cell are provided. The system includes a fuel cell having an anode chamber and a cathode chamber. After the fuel cell is shutdown, water vapor may linger within the anode and cathode chambers. The system includes dehumidifier source containing a hygroscopic hydrolyzing chemical, such as sodium silica gel or sodium silicide. The dehumidifier source is operatively connected in selective fluid communication with the anode chamber. When the fuel cell is shutdown, air can be prevented from entering the anode chamber, and fluid communication between the dehumidifier source and the anode chamber is permitted such that the hygroscopic hydrolyzing chemical reacts with water vapor in the anode chamber to produce hydrogen. Hydrogen can be used to pressurize the anode and cathode chambers and to purge the anode chamber of contaminants and water vapor during fuel cell shutdown. The system can prolong the operational life of the fuel cell.

### FIELD

Embodiments relate in general to fuel cells and, more particularly, to fuel cells in which liquid water is formed within the anode and/or cathode chambers of the fuel cell.

### BACKGROUND

Fuel cells generate electrical power that can be used in a variety of applications. Fuel cells constructed with proton exchange membranes (PEM fuel cells) have an ion exchange membrane, partially comprised of a solid electrolyte, affixed between an anode chamber and a cathode chamber. To produce electricity through an electrochemical reaction, hydrogen is supplied to the anode, and air is supplied to the cathode. An electrochemical reaction between the hydrogen and the oxygen in the air produces an electrical current. One of the byproducts of the energy-generating electrochemical reaction in the fuel cell is water vapor.

The operational lifetime of a fuel cell may be adversely affected by condensation of water vapor that remains within the anode and cathode chambers after the fuel cell system is shutdown, Typically, water in the form of vapor does not adversely affect fuel cell performance. However, during shutdowns, the left over reactant gases within the fuel cell anode and cathode chambers are water vapor-rich. As the temperature of the fuel cell decreases and approaches atmospheric temperature, the water vapor in the fuel cell anode and cathode chambers can condense, potentially causing flooding and damage to the membrane electrode assembly (MEA), thereby degrading the fuel cell performance and durability. Such flooding can be especially problematic when reformation is employed as a source of hydrogen for the fuel cell system, as hydrogen derived by reformation carries a relatively high water vapor concentration.

One solution to water vapor elimination during shutdowns has been purging the anode and cathode chambers with an inert dry gas, such as carbon dioxide or nitrogen, or with a dry fuel. These solutions have drawbacks because they require the onboard storage of the purging gas, which increases the weight of the system and results in more frequent refueling. Further, if a gaseous fuel is used, the purge results in waste and loss of overall operational efficiency. On the other hand, the purging approach is further complicated with systems that use liquid fuels, since the fuel would have to be reformed or vaporized prior to introduction into the fuel cell. Both processes consume fuel and thus contribute to the lower system efficiency.

Therefore, there is a need for a system and method that can minimize such concerns.

### SUMMARY

Embodiments of the invention are directed to systems and methods for fuel cell dehumidification. In a first embodiment of the invention, a fuel cell system is provided. The system includes a fuel cell having an anode chamber and a cathode chamber. The system also includes a hydrogen source that is operatively connected in selective fluid communication with the anode chamber of the fuel cell. During fuel cell operation, hydrogen from the hydrogen source is supplied to the anode chamber of the fuel cell and during fuel cell shutdown, the supply of hydrogen to the anode chamber of the fuel cell is restricted. The system also includes a dehumidifier source containing a hygroscopic hydrolyzing chemical, where the dehumidifier source is operatively connected in selective fluid communication with the anode chamber of the fuel cell. During fuel cell shutdown, fluid communication between the dehumidifier source and the anode chamber is permitted such that the hygroscopic hydrolyzing chemical reacts with water vapor in the anode chamber.

In a second embodiment of the invention, a method is provided for dehumidifying a fuel cell system including a fuel cell having an anode chamber having water vapor therein, a cathode chamber, a hydrogen source, and a dehumidifier source, where the hydrogen source is operatively connected in selective fluid communication with the anode chamber of the fuel cell and where the dehumidifier source is operatively connected in selective fluid communication with the anode chamber of the fuel cell. The method includes the steps of restricting the supply of hydrogen to the anode chamber during fuel cell shutdown, and selectively permitting fluid communication between the anode chamber and the dehumidifier source such that the dehumidifier reacts with the water vapor in the anode chamber to produce gas which pressurize the anode chamber.

In the various embodiments, the hygroscopic hydrolyzing chemical is one of a hydride, a silicide or an alkali silica gel, such as sodium silica gel (Na[SiO₂₋ₙ(OH)ₙ]) or sodium silicide (NaSi).

### BRIEF DESCRIPTION OF THE DRAWINGS

FIG. 1 is a diagrammatic view of a first fuel cell dehumidification system.

FIG. 2 is a diagrammatic view of a second fuel cell dehumidification system.

FIG. 3 is a diagrammatic view of a third fuel cell dehumidification system.

FIG. 4 is a chart showing the mass of sodium silicide required for 10 year operation of a fuel cell versus the volume of the anode chamber and/or cathode chamber.

### DETAILED DESCRIPTION

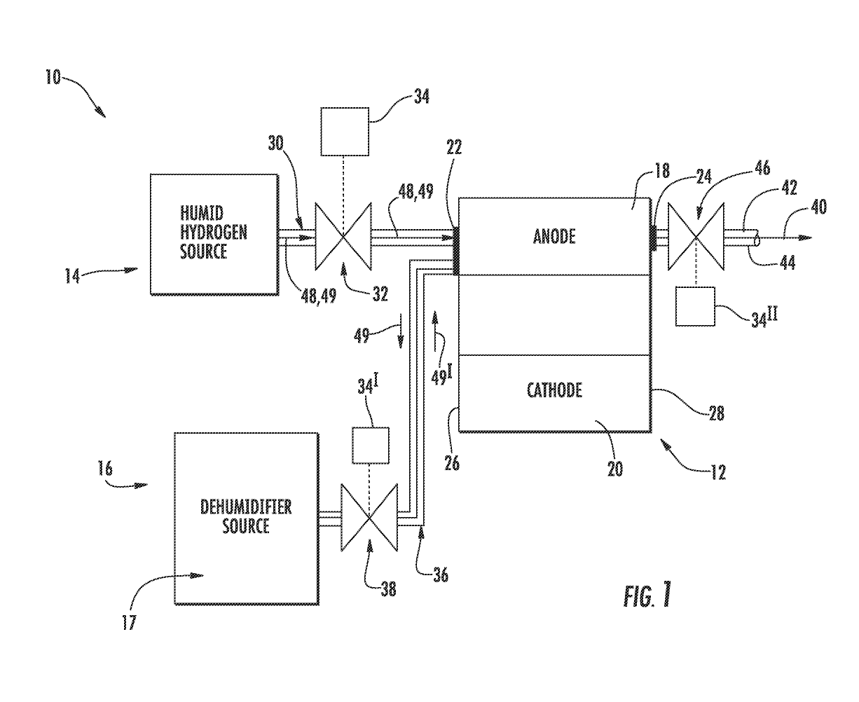

Embodiments are directed to fuel cell dehumidification systems and methods. Aspects will be explained in connection with various possible systems and associated operational methods, but the detailed description is intended only as exemplary. Embodiments are shown in FIGS. 1-4, but the embodiments are not limited to the illustrated structure or application. It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

Embodiments describe herein can be used to remove or reduce the humidity within the anode chambers and cathode chambers of a fuel cell. FIG. 1 shows one example of a fuel cell dehumidification system 10. The system can include a fuel cell 12, a hydrogen source 14 and a dehumidifier source 16.

The fuel cell 12 can include an anode chamber 18 and a cathode chamber 20. The fuel cell 12 may include a single cell, or it can comprise a plurality of cells. The fuel cell 12 can be any type of fuel cell, including, for example, a low temperature PEM fuel cell, a high temperature PEM fuel cell, or a phosphoric acid fuel cell. The anode chamber 18 can have an inlet 22 and an outlet 24. Likewise, the cathode chamber 20 can have an inlet 26 and an outlet 28.

As noted above, the system 10 also includes a hydrogen source 14. The hydrogen source 14 can contain hydrogen 48 in any suitable form. The hydrogen 48 can be produced in any suitable manner, such as by reformation, hydrolysis, electrolysis, photolysis, photoelectrolysis, photoelectrocatalysis, biodegradation, thermolysis, etc. The hydrogen 48 can be supplied to the hydrogen source 14 in any suitable manner,

The hydrogen 48 can be humid. That is, the gas available from hydrogen source 14 will include at least some minimum amount of water vapor 49. The humidity of the hydrogen 48 may be due to one or more factors. For example, this humidity may be a result of water management requirements for the fuel cell 12, or it may be a result of fuel production, or it may be a result of product water diffusion from the cathode side. The hydrogen source 14 can be connected in selective fluid communication with the anode chamber 18 of the fuel cell 12. Such connection can be achieved using any suitable manner. For instance, a first conduit 30 can extend between the hydrogen source 14 and the inlet 22 of the anode chamber 18. The first conduit 30 can be tubing, piping and/or one or more fittings, just to name a few possibilities.

The flow of gas between the hydrogen source 14 and the anode chamber 18 can be selectively controlled, Such selective control of the flow can be achieved in any suitable manner. For instance, a first valve 32 can be operatively positioned between the hydrogen source 14 and the anode chamber 18, such as along the first conduit 30.

The first valve 32 can be any suitable type of valve. In one operational mode, the first valve 32 can be in a closed position in which fluid communication between the hydrogen source 14 and the anode chamber 18 is restricted. In another operational mode, the first valve 32 can be in one or more open positions in which fluid communication between the hydrogen source 14 and the anode chamber 18 is permitted.

A controller 34 can be operatively connected to the first valve 32. The controller 34 can selectively vary the operational mode of the first valve 32. The controller 34 can be programmable. Thus, the controller 34 can be programmed to activate the first valve 32 upon the occurrence of a predetermined condition or responsive to instructions from an operator. In one embodiment, the controller 34 can be integrated with the first valve 34. The controller 34 can receive programming in any suitable manner.

As noted above, the system 10 includes a dehumidifier source 16. The dehumidifier source 16 can be a canister, enclosure, container, chamber or other suitable structure in which a hygroscopic and hydrolyzing chemical 17 can be stored. Any suitable hygroscopic/hydrolyzing chemical 17 can be used. For instance, the hygroscopic/hydrolyzing chemical 17 can be a hydride, silicide, or other suitable chemical that can produce hydrogen from hydrolysis. In one embodiment, the hygroscopic/hydrolyzing chemical 17 can be sodium silicide (NaSi), which is a hygroscopic solid and has a high reactivity with water. In another embodiment, the hygroscopic/hydrolyzing chemical 17 can be an alkali metal silica gel, For example, such as sodium silica gel (Na[SiO₂₋ₙ(OH)ₙ]).

The dehumidifier source 16 can be operatively connected in fluid communication with the anode chamber 18 of the fuel cell 12. Such operative connection can be achieved in any suitable manner. For instance, a second conduit 36 can extend between the dehumidifier source 16 and the inlet 22 of the anode chamber 18. The second conduit 36 can be tubing, piping and/or one or more fittings, just to name a few possibilities. In some embodiments, the first conduit 30 and the second conduit 36 can be merged at any point beyond valve 38.

The flow of water vapor from anode chamber 18 and to the dehumidifier source 16 and the hydrogen gas from the dehumidifier source 16 to the anode chamber 18 can be selectively controlled. Such selective control of the flow can be achieved in any suitable manner. For instance, a second valve 38 can be operatively positioned between the dehumidifier source 16 and the anode 18, such as along the second conduit 36. A controller 34^{I} can be operatively connected to the second valve 38. The above discussion of the first valve 32 and the controller 34 apply equally to the second valve 38 and the controller 34^{I}, The second valve 38 can have a separate controller 34^{I} dedicated thereto, or there may be a single controller operatively connected to both the first and second valves 32, 18.

Gases in the anode chamber 18 can be exhausted from the anode chamber 18 in any suitable manner. For instance, anode exhaust gas 40 can exit from the anode chamber 18 by an anode exhaust conduit 42, which can be, for example, as a flue 44, In one embodiment, the anode exhaust gas 40 can be released to the atmosphere. Alternatively or in addition, the anode exhaust gas 40 can be used for other beneficial purposes in the system 10,

The flow of anode exhaust gas 40 along the anode exhaust conduit 42 can be selectively controlled. Such selective control of the flow of anode exhaust gas 40 can be achieved in any suitable manner. For instance, a third valve 46 can be operatively positioned along the anode exhaust conduit 42, A controller 34^{H} can be operatively connected to the third valve 46. The above discussion of the first valve 32 and the controller 34 can apply equally to the third valve 46 and the controller 34^{H}. The third valve 46 can have a separate controller 34^{H} dedicated thereto. Alternatively, there may be a single controller operatively connected to the third valve 46 as well as the first valve 32 and/or the second valve 38.

Now that the individual components of a first embodiment of the system 10 have been described, an example of the operation of the system 10 will be described. During operation of the fuel cell 12, the first valve 32 can be in an open position. As a result, hydrogen from the hydrogen source 14, including dry hydrogen 48, hydrogen 48 and water vapor 49, or reformate, can flow to the anode chamber 18. The hydrogen 48 can electrochemically react in the fuel cell 12, in any known manner. In the case of a proton-exchange membrane (PEM) fuel cell, the hydrogen can be dissociated in the anode chamber 18 into hydrogen ions and electrons. The hydrogen ions can pass from the anode chamber 18 through the proton-exchange membrane to the cathode chamber 20, The electrons can be conducted through an external electrical circuit to the cathode chamber. An exothermic electrochemical reaction can be driven at the cathode chamber 20 by combining hydrogen ions, the electrons and oxygen to generate water, heat and electricity.

As described above, the gas from hydrogen source 14 can have a certain level of humidity. As a result, water vapor 49 will exist in the anode chamber 18 when the fuel cell 12 is in operation. The second valve 38 is in the closed position during fuel cell operation, thereby preventing the reaction of the hygroscopic hydrolyzing chemical with the water vapor 49 contained in the anode chamber 18. The third valve 46 can be in an open or closed position depending on the hydrogen purge rate used for proper fuel cell operation.

When the fuel cell 12 is shutdown, the first valve 32 and the second valve 46 can be in a closed position. As a result, air is prevented from entering the anode chamber 18 of the fuel cell 12. The third valve 38 can be in an open position to allow fluid communication between the dehumidifier source 16 and the anode chamber 18 of the fuel cell 12.

When third valve 38 is open, gases from anode chamber 18, including water vapor 49, can difuse in conduit 36 to dehumidifier source 16. Thereafter, the hygroscopic hydrolyzing chemical 17 is able to react with the water vapor 49 contained in the anode chamber 18 thereby producing hydrogen 49^{I}. The hydrogen 49^{I} can then flow to anode chamber 18 via conduit 36. For example, as noted above, the hygroscopic hydrolyzing chemical 17 can be sodium silicide (NaSi), which is a hygroscopic solid with high reactivity with water. In such case, the sodium silicide can spontaneously react with water vapor present in the anode chamber 18 of the fuel cell 12. The product of the reaction is hydrogen and sodium silicate (Na₂Si₂O₅). The reaction is shown below:

2NaSi+5H₂O→5H₂+Na₂Si₂O₅

This reaction has been shown to occur with good stability at temperatures lower than about 400 degrees Celsius. Hydrogen, as the gaseous product of the reaction, can be used to pressurize the anode chamber 18 and to purge the anode chamber 18 of contaminants and water vapor 49 during shut down of the fuel cell 12 by controlling the third valve 46. Such actions can help to preserve the fuel cell 12 and prolong its operational life. Sodium silicate or other reaction products associated with the reaction of hygroscopic hydrolyzing chemical 17 can also decrease the water amount in anode chamber 18 by adsorption.

The reaction of the hygroscopic hydrolyzing chemical 17 with the water vapor 49 will decrease in rate as the partial pressure of the water in the anode chamber is decreased. This effect can be counterbalanced as the temperature of the fuel cell 12 approaches ambient temperature, thus increasing the partial pressure of water vapor 49 in the anode chamber 18. This condition can ensure that the proper rate of reaction is attained to reduce water condensation in the anode chamber 18 of the fuel cell 12 throughout the shutdown period.

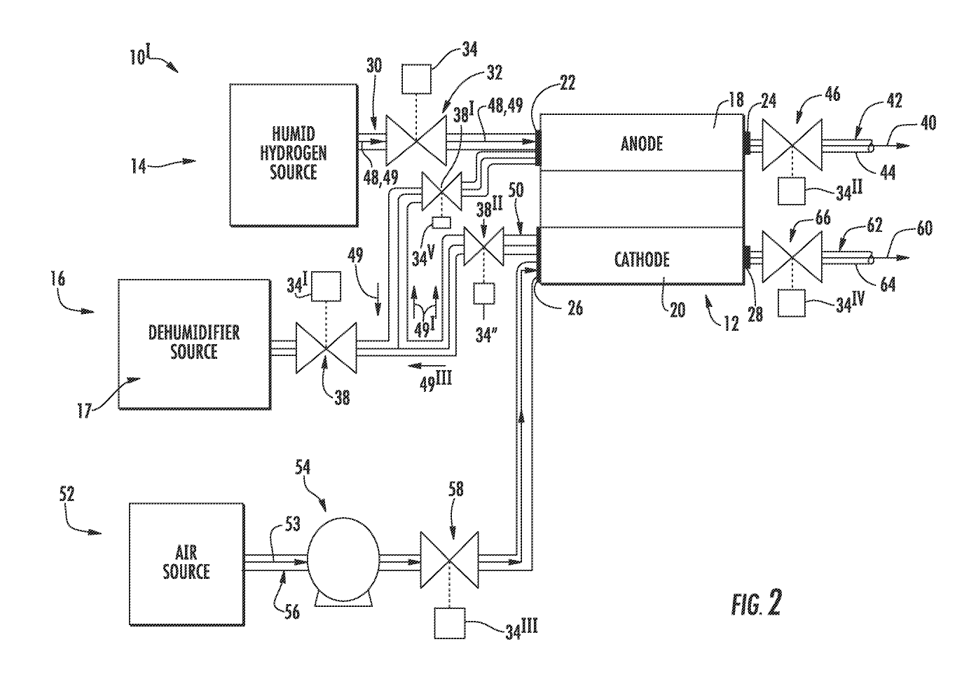

While the foregoing description concerns dehumidification of the anode chamber 18 of the fuel cell 12, it will be appreciated that both the anode chamber 18 and the cathode chamber 20 of the fuel cell 12 can be dehumidified. FIG. 2 shows an embodiment of a system 10^{I} that dehumidifies and purges both the anode and cathode chambers 18, 20 of the fuel cell 12. The above description made in connection with the system 10 shown in FIG. 1 is equally applicable to the system 10^{I} shown in FIG. 2. Thus, the following description will be directed to differences in the structure and/or operation.

The dehumidifier source 16 can be operatively connected in fluid communication with the cathode chamber 20 of the fuel cell 12 in addition to the anode chamber 18. Such operative connection can be achieved using any suitable manner. For example, a third conduit 50 can be provided. In one embodiment, the third conduit 50 can be provided in branched relation to the second conduit 36, as is shown in FIG. 2. The third conduit 50 can be in fluid communication with the second conduit 36 at one end and with the cathode chamber 20 of the fuel cell 12 at the other end thereof In order to prevent mixture of gases from the anode chamber 18 and cathode chamber 20 during fuel cell operation, sixth and seventh valves 38^{I} and 38^{II} replace the second valve 38 in the previous embodiment. The separation of anode chamber 18 and cathode chamber 20 can be achieved through any other suitable mean.

Controllers 34^{V} and 34^{VI} can be operatively associated with valves 38^{I} and 38^{II}, respectively. The above discussion of the first valve 32 and the controller 34 apply equally to the valves 38^{I} and 38^{I} and controllers 34^{V} and 34^{VI}. The controller associated with each of these valves can be a dedicated controller or it can be a central controller operatively connected the other valves.

Alternatively, the second conduit 36 and the third conduit 50 can be completely separate from each other. For example, the second conduit 36 can be operatively connected between the dehumidifier source 16 and the anode chamber 18, and the third conduit 50 can be operatively connected between the dehumidifier source 16 and the cathode chamber 20. In such case, a valve can be disposed along each conduit 36, 50 to control the flow of gases and water vapor to and from the hygroscopic hydrolyzing chemical 17 through each of the conduits 36, and 50.

It is worth noting that the hygroscopic hydrolyzing chemical 17 does not flow, but instead remains within the dehumidifier source 16, In contrast, gases remaining in the anode chamber 18 and cathode chamber 20 are allowed to flow to and through the hygroscopic hydrolyzing chemical 17. In such a configuration, this flow would primarily occur through diffusion. However, in some embodiments forced convection can be provided by using a pump, blower or compressor (not shown).

Further, the system 10^{I} can include an oxygen or air source 52. The air source 52 can be in fluid communication with the cathode chamber 20. In one embodiment, the air source 52 can be ambient air. The air 53 can be supplied to the cathode chamber 20 in any suitable manner. For example, an air circulation device 54, such as a compressor or a blower, can be used to facilitate the movement of air to the cathode chamber 20.

The air source 52 can be operatively connected in fluid communication with the inlet 26 of the cathode chamber 20 of the fuel cell 12. Such operative connection can be achieved in any suitable manner. For instance, a fourth conduit 56 can extend between the air source 52 and the inlet 26 of the cathode chamber 20 of the fuel cell 12. The fourth conduit 56 can be tubing, piping and/or one or more fittings, just to name a few possibilities.

The flow of air between the air source 52 and the cathode chamber 20 can be selectively controlled. Such selective control of the flow can be achieved in any suitable manner, For instance, a fourth valve 58 can be operatively positioned between the air source 52 and the cathode chamber 20, such as along the fourth conduit 56. A controller 34^{III} can be operatively associated with the fourth valve 58. The above discussion of the first valve 32 and the controller 34 apply equally to the fourth valve 58 and the controller 34^{III}, The controller associated with the fourth valve 58 can be an individual controller 34^{III} dedicated to the fourth valve 58, or it can be a central controller operatively connected to the fourth valve 58 as well as the first, sixth, seventh and/or third valves 32, 38^{I}, 38^{II}, 46.

Cathode exhaust gas 60 can exit the cathode chamber 20 in any suitable manner. For instance, cathode exhaust gas 60 can exit from the cathode chamber 20 by a cathode exhaust conduit 62, which can be, for example, a flue 64. The cathode exhaust gas 60 can be released to the atmosphere and/or used for other purposes in the system 10^{I}.

The flow of cathode exhaust gas 60 along the cathode exhaust conduit 62 can be selectively controlled. Such selective control of the flow can be achieved in any suitable manner. For instance, a fifth valve 66 can be operatively positioned along the cathode exhaust conduit 62. A controller 34^{IV} can be operatively associated with the fifth valve 66. The above discussion of the first valve 32 and the controller 34 apply equally to the filth valve 66 and the controller 34^{IV}, There can be a dedicated controller 34^{IV}operatively connected to the fifth valve 66. Alternatively, ⁻there can be a central controller that is operatively connected to the fifth valve 66 as well as the first valve, the sixth valve, the seventh valve, the third valve and/or the fourth valve 32, 38^{I}, 38^{II}, 46, 58,

During operation of the fuel cell system 10^{I} shown in FIG. 2, the first valve 32, the fourth valve 58 and the fifth valve 66 can be in an open position. The third valve 46 can be in an open or closed position depending on the rate of anode chamber 18 gas purging required to maintain proper fuel cell operation. As a result, oxygen (oxidant) from the air source 52 and hydrogen (fuel) from the hydrogen source 14 can enter the fuel cell 12 where electrochemical oxidation is occurring. The sixth and seventh valves 38^{I}, 38^{II} remain closed when fuel cell operates.

During shutdown, the first valve 32 and the fourth valve 58 are in a closed position. The sixth and seventh valves 38^{I} and 38^{II} are in an open position in order to allow operative fluid communication between the hygroscopic hydrolyzing chemical 17 and the anode chamber and cathode chamber 20, in a manner that would allow for reaction of the water vapor 49 contained in the anode chamber 18 and the water vapor 49^{II} contained in the cathode chamber 20 with the hygroscopic hydrolyzing chemical. The third valve 46 and the fifth valve 66 can be in open or closed position or can alternate between an open and closed positions as required to regulate anode chamber 18 and cathode chamber 20 gas pressure, or as required to purge the anode and cathode chamber 18 and 20 with gases emanating from the hydrolyzing reaction of the hygroscopic hydrolyzing chemical 17 with the water vapor 49 contained in the anode chamber 18 and the product water vapor 49^{II} contained in the cathode chamber 20. Note that in this configuration, the water vapor 49, 49¹¹ in the anode chamber 18 and cathode chamber 20 reacts to produce hydrogen 49^{I}, which then dilutes gases remaining in the chambers 18 and 20 and fills these chambers with hydrogen 49^{I}. Once the sixth valve 38^{I} and the seventh valve 38^{II} are open, the cathode chamber 20 and anode chamber 18 of the fuel cell 24 are in effective fluid connection, which results in equalized pressure between the anode chamber 18 and the cathode chamber 20.

The selective movement of the valves 32, 38^{I}, 38^{II}, 46, 58, 66 between the open and closed positions can be varied to optimize the shutdown of the fuel cell 12. For instance, dehumidification, purging and isolation of the anode chamber 18 can occur at least partially simultaneously with the dehumidification, purging and isolation of the cathode chamber 20, Alternatively, the dehumidification, purging and isolation of the anode chamber 18 can occur at a. different time from the dehumidification, purging and isolation of the cathode chamber 20. For instance, the dehumidification, purging and isolation of the anode chamber 18 can occur either before or after the dehumidification, purging and isolation of the cathode chamber 20. The final shutdown of the fuel cell 12 can occur when all water is removed from the anode and cathode chambers 18, 20, and when both the anode and cathode chambers 18, 20 are filled with hydrogen from the hydrolysis reaction in dehumidifier 16. This may be desirable because it can completely stop the fuel cell electrochemical reaction while the fuel cell 12 is shutdown. At this point, the voltage of the fuel cell 12 should be about zero.

To start-up the fuel cell system 10^{I} of FIG. 2, the fourth valve 58 and the fifth valve 66 can be opened in such a way to allow a controlled quantity of air into the cathode chamber 20. Most fuel cells use platinum based catalyst as part of their anode and cathode electrodes in the membrane electrode assembly (MEA). These catalysts are generally highly efficient and would trigger the hydrogen oxidation reaction in the presence of the small oxygen amounts in the cathode chamber 20. The oxidation reaction could occur inside the cathode chamber 20 of the fuel cell 12. Since this reaction is extremely exothermic, it could be used to raise the temperature of the fuel cell 12 in a controlled manner until the operating temperature of the fuel cell 12 is reached. The high catalyst surface area can increase the heat-up speed of the fuel cell 12.

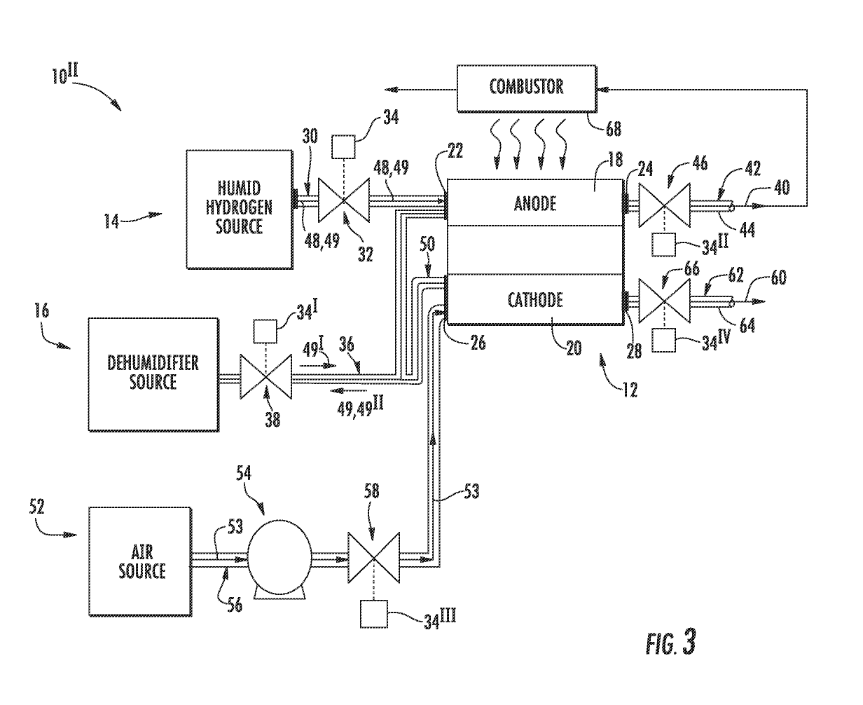

The generation of hydrogen from the hydrolysis reaction could also be used to reduce the rate of temperature decline of the fuel cell 12. This is especially important for fuel cells 12 that operate at elevated temperatures, such as high temperature PEM fuel cells and phosphoric acid fuel cells, because it may reduce start-up time and energy requirements, One example of such a system 10^{II} is shown in FIG. 3. The above description made in connection with the systems 10, 10^{I} shown in FIGS. 1 and 2 is equally applicable to the system 10^{II} shown in FIG. 3. The following description will be directed to differences in the structure and/or operation.

The system 10^{II} can include a combustor 68. Any suitable combustor 68 can be used, In one embodiment, the combustor 68 can be a catalytic combustor. In another embodiment, the combustor 68 may be a non-catalytic combustor. The combustor 68 can be operatively connected in selective fluid communication with the anode chamber 18 such that at least a. portion of anode exhaust gas 40 can be supplied the combustor 68. The combustor 68 can oxidize anode exhaust gas 40,

The temperature drop of the fuel cell 12 could be reduced during shutdown by allowing the hydrolysis reaction to occur and generate hydrogen that is evacuated through the second valve 38, anode chamber 18, and the third valve 46 into the combustor 68. The heat generated by the combustor 68 can be transferred back to the filet cell 12 to maintain its temperature. Thus, the combustor 68 can be operatively associated in heat exchanging relation with the fuel cell 12. Such heat transfer can be achieved in any suitable manner. As the water in the anode chamber 18 is consumed, the rate of hydrogen evolution would decrease and the heat production from the combustor 68 would also decrease,

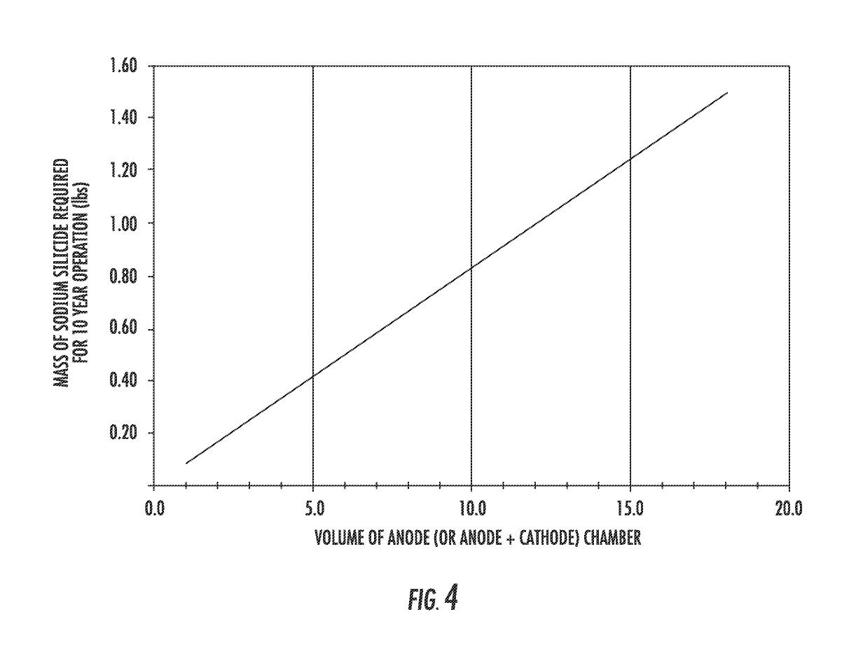

In any of the embodiments of a fuel cell dehumidification system 10, 10^{I}, 10^{II}, the amount of dehumidifier for the system 10, 10^{I}, 10^{II}can be an important consideration in the design of the system. The amount will vary based on the shutdown strategy employed and the physical volume of the anode chamber 18 and the cathode chamber 20. FIG. 4 presents a graph of the amount of sodium silicide (NaSi) consumed during estimated 10 years of fuel cell operation for various cathode or anode or combined cathode and anode chamber volumes. The analysis underlying this graph assumes that hydrogen introduced into the stack is diluted by 18% v/v water vapor (typical for reformed hydrogen) and that the system consumes enough water vapor to purge the volume five times per shutdown, it was further assumed that the system would be shut down and started up four times per day. The results show that the amount of sodium silicide required would be relatively small, less than 2 pounds, for almost all potential fuel cell systems.

Dehumidifying systems for a fuel cell can provide numerous advantages. For instance, the dehumidifying systems can efficiently eliminate water vapor even at very low water partial pressures. Because the typical amount of water that needs to be removed during shutdowns is low, the amount of hydride, silicide, or other chemical consumed by hydrolysis per fuel cell shutdown is also low. Therefore, the onboard weight and the replacement rate of the hygroscopic, hydrolyzing chemical are low.

Examples have been described above regarding a fuel cell dehumidification system and method. It will of course be understood that embodiments are not limited to the specific details described herein, which are given by way of example only, and that various modifications and alterations are possible within the scope of the following claims.

What is claimed is:

1. A fuel cell system, comprising:
a fuel cell having an anode chamber and a cathode chamber;
a hydrogen source, the hydrogen source being operatively connected in selective fluid communication with the anode chamber of the fuel cell, whereby, during fuel cell operation, hydrogen from the hydrogen source is supplied to the anode chamber of the fuel cell and whereby, during fuel cell shutdown, the supply of hydrogen to the anode chamber of the fuel cell is restricted; and
a dehumidifier source containing a hygroscopic hydrolyzing chemical, the dehumidifier source being operatively connected in selective fluid communication with the anode chamber of the fuel cell, whereby during fuel cell shutdown fluid communication between the dehumidifier source and the anode chamber is permitted such that the hygroscopic hydrolyzing chemical reacts with water vapor in the anode chamber.

2. The system of claim 1 wherein the hygroscopic hydrolyzing chemical is one of a hydride, a silicide or an alkali metal silica gel.

3. The system of claim 1 wherein the hygroscopic hydrolyzing chemical is sodium silica e (Na[SiO₂₋ₙ(OH)ₙ]).

4. The system of claim 1 wherein the hygroscopic hydrolyzing chemical is sodium silicide (NaSi).

5. The system of claim 1 further including a first valve operatively positioned between the hydrogen source and the anode chamber of the fuel cell to provide selective fluid communication there between, the valve including an open position in which fluid communication is permitted between the hydrogen source and the anode chamber of the fuel cell and a closed position in which fluid communication between the hydrogen source and the anode chamber of the fuel cell is restricted, whereby the valve can be in the open position during fuel cell operation and in the closed position during fuel cell shutdown.

6. The system of claim 1 further including a valve operatively positioned between the dehumidifier source and the anode chamber of the fuel cell to provide selective fluid communication there between, the valve including an open position in which fluid communication is permitted between the dehumidifier source and the anode chamber of the fuel cell and a closed position in which fluid communication between the dehumidifier source and the anode chamber of the fuel cell is restricted, whereby the valve can be in the open position during fuel cell shutdown and in the closed position during fuel cell operation.

7. The system of claim 1 further including a valve operatively positioned relative to the outlet of the anode chamber of the fuel cell to provide selective fluid communication therewith, the valve including an open position in which fluid communication is permitted with the anode chamber of the fuel cell and a closed position in which fluid communication with the anode chamber of the fuel cell and is restricted, whereby the valve can be in the open position during fuel cell operation and in the closed position during fuel cell shutdown.

8. The system of claim 1 wherein the dehumidifier source is operatively connected in selective fluid communication with the cathode chamber, whereby, during fuel cell shutdown, fluid communication between the dehumidifier source and the cathode chamber is permitted such that the hygroscopic hydrolyzing chemical reacts with water vapor in the cathode chamber.

9. The system of claim 8 further including an air source in selective fluid communication with the cathode chamber.

10. The system of claim 9 further including a valve operatively position between the air source and the cathode chamber of the fuel cell to provide selective fluid communication there between, the valve including an open position in which fluid communication is permitted between the air source and the cathode chamber and a closed position in which fluid communication between the air source and the cathode chamber is restricted, wherein the valve is in the open position during fuel cell operation and closed during fuel cell shutdown,

11. The system of claim 8 further including an air circulation device operatively positioned to move air from the air source to the cathode chamber.

12. The system of claim 1 further including a combustor operatively positioned in selective fluid communication with the anode chamber, whereby at least a portion of anode exhaust gas can be supplied to the combustor to generate heat, the combustor being operatively positioned in heat exchanging relation with the fuel cell, whereby at least a portion of the heat generated by the combustor is transferred back to the fuel cell to maintain its temperature.

13. A method for dehumidifying a fuel cell system, the system including filet cell having an anode chamber and a cathode chamber, the anode chamber having water vapor therein, a hydrogen source and a dehumidifier source, the hydrogen source being operatively connected in selective fluid communication with the anode chamber of the fuel cell, the dehumidifier source being operatively connected in selective fluid communication with the anode chamber of the fuel cell, the method comprising the steps of:
during fuel cell shutdown, restricting the supply of hydrogen to the anode chamber; and
selectively permitting fluid communication between the anode chamber and the dehumidifier source such that the dehumidifier reacts with the water vapor in the anode chamber to produce gas which pressurize the anode chamber.

14. The method of claim 13 wherein the hygroscopic hydrolyzing chemical is one of a hydride, a suicide or an alkali metal silica gel.

15. The method of claim 13 further including the step of selectively permitting fluid communication between the anode chamber and outside the anode chamber so as to purge the gas from the anode chamber.

16. The method of claim 15 further including the steps of:
supplying at least a portion of the purged gas to a combustor, wherein the combustor generates heat; and
transferring at least a portion of the heat to the fuel cell.

17. The method of claim 13 wherein the cathode chamber has water vapor therein, and further including steps of
selectively permitting fluid communication between an air source and cathode chamber; and
selectively permitting fluid communication between the cathode chamber and the dehumidifier source such that the dehumidifier reacts with the water vapor in the cathode chamber, thereby producing purge gases which pressurize the cathode chamber.

18. The method of claim 17 wherein the step of selectively permitting fluid communication between the cathode chamber and the dehumidifier source is performed at a different time than the step of selectively permitting fluid communication between the anode chamber and the dehumidifier source.

19. The method of claim 18 further including the step of selectively permitting fluid communication between the cathode chamber and outside the cathode chamber so as to exhaust the purge gases from the cathode chamber.

20. The method of claim 13 further including the steps of:
starting the fuel cell;
selectively restricting fluid communication between the anode chamber and the dehumidifier source; and
selectively permitting fluid communication between the humid hydrogen source and the anode chamber.
